(19) United States
(12) Patent Application Publication
(10) Pub. No.: US 2012/0182917 A1
(43) Pub. Date: Jul. 19, 2012

(54) IMPLANTABLE MEDICAL DEVICE COMMUNICATION

(75) Inventor: Par Edlund, Sollentuna (SE)

(73) Assignee: ST. JUDE MEDICAL AB, Jarfalla (SE)

(21) Appl. No.: 13/496,470

(22) PCT Filed: Sep. 16, 2009
(86) PCT No.: PCT/SE2009/000411

§ 371 Date: Mar. 15, 2012

(51) Int. Cl. H04W 52/02

(52) U.S. Cl. 370/311

(57) ABSTRACT

An implantable medical device, IMD, tags data packets transmitted to a non-implantable communication unit with notifications indicating whether the IMD has additional data that needs to be transmitted to the communication unit. The notifications are used by the communication unit to achieve a conditional generation and transmission of power down requests that urges the IMD to power down its radio equipment. The total length of the communication session can thereby be reduced as power down requests are not transmitted when the IMD has additional data to transmit.

### TECHNICAL FIELD

The present invention generally relates to implantable medical devices, and in particular to conducting wireless communication between an implantable medical device and a non-implantable communication unit.

### BACKGROUND

The traditional approach of conducting communication with an implantable medical device (IMD) has been through usage of inductive telemetry. Nowadays, the communication technology within the field of IMD is moving away from inductive telemetry towards radio frequency (RF) based telemetry or communication.

RF telemetry has several advantages over inductive telemetry including, for instance, higher bit rates and longer range. However, a drawback is that RF telemetry generally requires more power. IMDs are typically battery driven and therefore have limited operation lifes dictated by the power consumption of the IMDs. Utilizing RF telemetry as the communication protocol consequently causes an impact to the longevity of the IMDs.

In order to at least partly solve this problem of increased power consumption for RF-based communication sessions between IMDs and non-implantable communication units or modules, algorithms for reducing power have been developed. An example of such an algorithm is denoted power save and involves regularly turning off the radio equipment in the IMD for a certain time period, typically 20-30 ms, during a communication session. The power save algorithm is mainly based on the stream of electrocardiogram (EGM) data that is sent periodically in a burst-like manner from the IMD. For instance and depending on the particular device design, EGM samples can be produced by the IMD every 7.8125 ms. The IMD then preferably buffers a number of such EGM samples, such as six, prior transmission. The buffering of EGM samples yields a periodicity of, in this example, 6×7.8125=46.875 ms for the EGM messages sent from the IMD to the non-implantable communication unit.

Power saving can therefore be performed during those periods when the IMD buffers EGM samples.

Though the power save algorithm reduces power consumption by turning off the IMD radio equipment several times during an ongoing communication session it also, as a drawback, prolongs the communication session. The net result may therefore in some cases not be a power reduction but actually increased total power consumption for the whole communication session and thereby reduced longevity of the IMD.

U.S. Pat. No. 6,647,298 relates to saving power during the communication between an IMD and a non-implantable communication unit. The power saving is accomplished by selectively switching on and off the receiver of the IMD based on whether received signal strengths exceed a discriminator threshold.

### SUMMARY

There is therefore a need for a technique that can be used in connection with power saving algorithms during IMD-based communication sessions but that does not unnecessarily prolongs the total time for the communication session.

It is an objective to provide an improved data communication between an implantable medical device and a non-implantable communication unit.

It is a particular objective to provide a selective activation and deactivation of power down of IMD radio equipment during a communication session.

These and other objectives are met by embodiments as defined by the accompanying patent claims.

Briefly, an IMD is capable of wirelessly communication with a communication unit using RF telemetry. The IMD consequently comprises a RF transmitter and receiver connected to one or more RF antennas. A controller of the IMD is arranged for temporarily power down at least one of the RF transmitter and receiver based on a power down request from the communication unit. The IMD also comprises a tag processor adapted to tag at least a portion of the data packets compiled by the IMD and transmitted by the RF transmitter to the communication unit. The tagged data packets comprises a respective notification indicating whether the IMD has additional data that is to be transmitted to the communication unit and that is preferably currently present in a transmit buffer of the IMD.

The communication unit also comprises radio equipment, i.e. RF transmitter and receiver and one or more RF antennas, for wirelessly communicating with the IMD using RF telemetry. A request processor is implemented in the communication unit for generating power down requests that are transmitted to the IMD to cause a temporary power down of the IMD radio equipment. The operation of this request processor is controlled by a processor controller based on the notifications present in data packets received from the IMD. This means that the power down of the IMD radio equipment is made conditional on the data pending status of the IMD, i.e. whether the IMD has additional data to be transmitted to the communication unit.

In a preferred implementation, the processor controller generates a deactivation control command to cause the request processor to temporarily stop the generation of power down requests if a received notification indicates that there is more data pending in the IMD for transmission to the communication unit. Correspondingly, if a received notification indicates that no more data is pending for transmission, the processor controller generates an activation control command to activate the request processor to generate and transmit a power down request to the IMD.

An aspect also relates to a data communication method involving tagging, at an IMD, a data packet to be wirelessly transmitted by the IMD with a notification indicating whether a transmit buffer of the IMD comprises additional data packets to be wirelessly transmitted by the IMD. The tagged data packet is wirelessly transmitted to a non-implantable communication unit, where the notification allows a selective generation of a power down request triggering a power down of at least one of a transmitter and a receiver of the IMD.

Another aspect is directed towards a communication control method involving generation of power down requests defining a power down of at least one of a transmitter and a receiver of an IMD. A data packet tagged with a notification as previously described is received from the IMD. The method involves temporarily stopping the generation of the power down requests if the notification indicates that the IMD comprises additional data to be wirelessly transmitted to a non-implantable communication unit.

Embodiments of the invention will reduce the total time of a communication session utilizing a power saving procedure involving a temporary and typically periodic power down of the IMD radio equipment. Reducing the total time of the communication session will reduce the total power consumption of the IMD for the session and thereby increase the longevity of the IMD. Additionally, faster interrogation of IMDs is achieved as requested data can be faster delivered from the IMD without any interruption in the data delivery due to radio equipment power downs.

### BRIEF DESCRIPTION OF THE DRAWINGS

The invention, together with further objects and advantages thereof, may best be understood by making reference to the following description taken together with the accompanying drawings, in which:

FIG. 1 is a schematic overview of an embodiment of a data communication system comprising an implantable medical device, a non-implantable communication unit and a data processing unit;

FIG. 2 is a schematic overview of another embodiment of a data communication system comprising an implantable medical device and a programmer;

FIG. 3 is a schematic block diagram of an implantable medical device according to an embodiment;

FIG. 4 is a schematic block diagram of a communication unit according to an embodiment;

FIG. 5 is a schematic block diagram of a programmer according to an embodiment;

FIG. 6 is a signal diagram illustrating a portion of a communication session involving an implantable medical device, a non-implantable communication unit and a data processing unit;

FIG. 7 is another signal diagram illustrating a portion of a communication session involving an implantable medical device, a non-implantable communication unit and a data processing unit;

FIG. 8 is a further signal diagram illustrating a portion of a communication session involving an implantable medical device, a non-implantable communication unit and a data processing unit; and

FIG. 9 is a signal diagram illustrating a portion of a communication session involving an implantable medical device, a non-implantable communication unit and a data processing unit according to prior art techniques.

### DETAILED DESCRIPTION

Throughout the drawings, the same reference numbers are used for similar or corresponding elements.

The present invention is generally related to data communication between an implantable medical device (IMD) and a non-implantable communication unit. More particularly, the invention is directed towards techniques for shortening the time duration of a radio frequency (RF) communication session involving the IMD and the non-implantable communication unit.

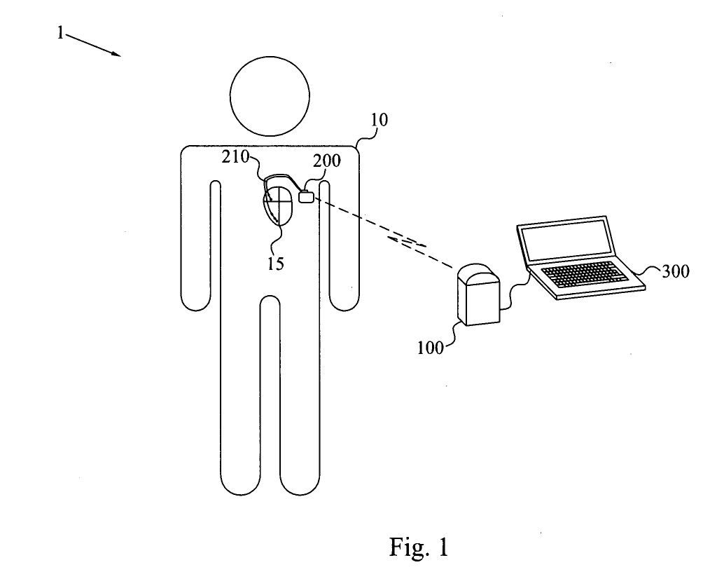

FIG. 1 is a schematic overview of a data communication system 1 according to an embodiment. The data communication system 1 comprises an IMD 200, illustrated as being implanted in a human body 10 in the figure. The IMD 200 of the embodiments can actually be any implantable medical device capable of delivering therapy to an animal, preferably mammalian and more preferably human body 10, and/or capable of recording physiological data and parameters from the body 10. The figure non-limitedly illustrates the IMD 200 as a device monitoring and/or providing therapy to the patient's heart 15 and consequently comprises one or more connectable cardiac leads 210 provided in or in connection to one or more ventricles and/or atriums of the heart 15. The IMD 200 could therefore be a pacemaker, defibrillator or cardioverter. However, the present invention is not limited to cardiac-associated IMDs 200 but may also be practiced with other implantable medical devices 200, such as drug pumps, neurological stimulators, physical signal recorders, oxygen sensors, or the like. The important feature of the IMD 200 is that is contains equipment capable of conducting wireless RF-based communication with the communication unit 100 of the data communication system 1.

The communication unit 100 operates as a base station of the data communication system 1 in that it constitutes the interface between the IMD 200 and an external instrument or data processing unit 300, such as a programmer for the IMD 200. This means that the communication unit 100 contains the equipment for effecting the wireless RF-based communication with the IMD 200 on behalf of the data processing unit 300. Thus, data requests from the data processing unit 300 are processed and packed into data packets and transmitted to the IMD 200 by the communication unit 100. Additionally, data packets received from the IMD 200 by the communication unit 100 can be forwarded to the data processing unit 300 for further processing and/or display therein.

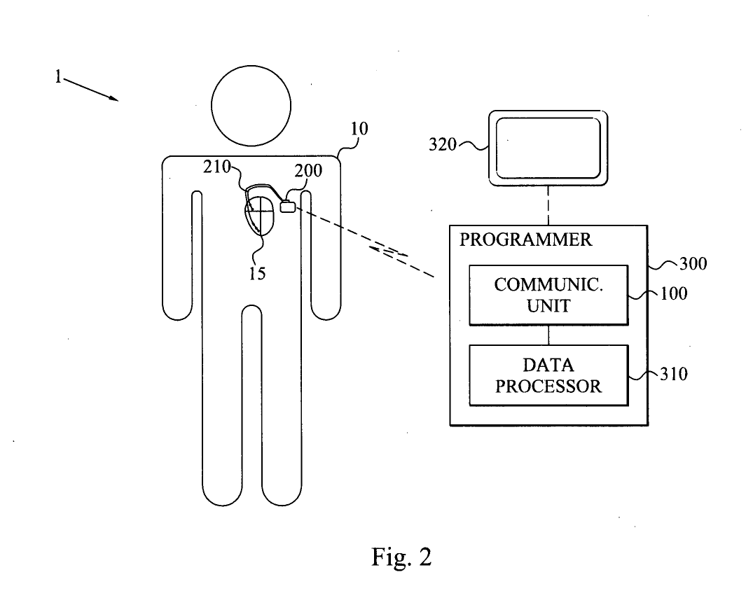

The communication unit 100 and the data processing unit 300 can be separate devices as illustrated in FIG. 1, either wired connected or using a wireless connection, such as Bluetooth®, an infrared (IR) connection or a RF connection. In an alternative embodiment, as illustrated in FIG. 2, the functionality and equipment of the communication unit 100 and the data processing part of the data processing unit, here illustrated by a data processor 310, can be housed in a same device 300, such as a physician's programmer or workstation 300. The programmer 300 can additionally comprise or be connected to a display screen 320 for displaying the physiological data collected by the IMD 200 and wirelessly transmitted to the communication unit 100 and processed by the data processor 310 of the programmer 300.

RF-based communication with an IMD introduces new challenges as compared to inductive telemetry. Generally, RF telemetry requires more power than inductive telemetry, which will drain the battery driven IMD and can have a negative impact on the longevity and operation life of the IMD. Consequently, power saving algorithms applicable during an ongoing RF-based communication session have been developed. An example of such a power saving algorithm is to regularly turn off the radio equipment, i.e. transmitter and receiver, of the IMD during the communication session. This means that this equipment part of the IMD will actually only consume power from the battery during a part of the whole time period of the communication session. The inventor has, though, realized that such a power saving algorithm can introduce new problems and disadvantages, which prolong the total time of the communication session and may, in certain cases, cause increased power consumption and reduced longevity for the IMD.

The present invention solves this problem of radio power down algorithms by making such power down conditional on whether the IMD comprises data to be transmitted to the non-implantable communication unit. In a basic embodiment, as long as the IMD comprises data that should be transmitted to the non-implantable communication unit during the ongoing RF-based communication session, the communication unit should refrain from requesting the IMD to power down its radio equipment. In clear contrast, the data should be transmitted to the communication unit before the power saving algorithm triggers the IMD to power down the radio equipment. Correspondingly, once the IMD no longer has any more data to transmit, the power saving algorithm can trigger a power down or even complete switch off of the IMD radio equipment unless the communication session should be ended

This conditional power down proposed by the embodiments reduces the risk of unnecessarily long communication sessions due to repeated power down periods even though data transmission could be effected. This also achieves a faster forwarding of requested or interrogated data to the data processing unit connected to the communication unit or in which the communication unit is implemented. Additionally, since the communication session can be ended earlier according to embodiments, the power consumption in the IMD and also in the interrogating data processing unit and the communication unit can be decreased.

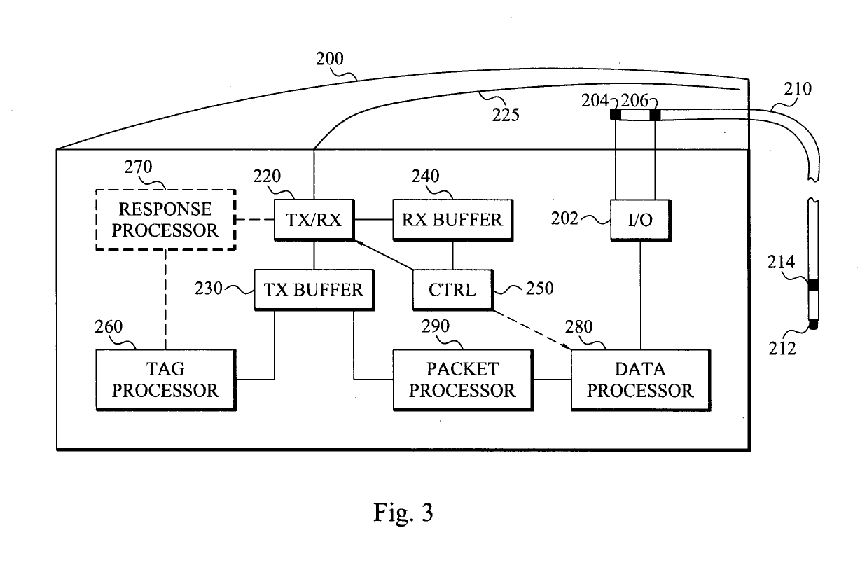

FIG. 3 is a schematic block diagram of an embodiment of an IMD 200 capable of conducting wireless RF-based communication with a non-implantable communication unit. The IMD 200 in particular comprises a receiver 220 connected to a RF antenna 225 and arranged for receiving data transmitted by the communication unit. Correspondingly, the IMD 200 also comprises a transmitter 220 connected to a RE antenna 225 and arranged for wirelessly transmit data packets to the communication unit. The receiver and transmitter 220 can be respective dedicated RF receiver and RF transmitter or represent the receiving branch and the transmitting branch of a combined RF transmitting and receiving unit or transceiver 220. The IMD 200 can include one or more dedicated RF receiver antennas 225 connected to the receiver 220 and one or more dedicated RF transmitter antennas 225 connected to the transmitter 220. However, in most practical implementations one and the same RF antenna or antenna arrangement is connected to both the receiver and transmitter 220 or to the common transceiver.

The IMD 200 comprises a controller 250 connected to the transmitter and/or receiver 220 or the single transceiver. The controller 250 performs a power down of the transmitter and/or receiver 220 or the single transceiver based on a power down request received by the receiver 220 and originating from the communication unit.

In an embodiment, the controller 250 only operates on the transmitter or the transmitting branch 220 of a transceiver. This means that the controller 250 then causes a power down of the transmitter or transmitting branch 220 based on the reception of the power down request. According to another embodiment, the controller 250 only operates on the receiver or the receiving branch 220 of a transceiver and causes a power down thereof based on the power down request. In the former embodiment the receiver or receiving branch 220 of the transceiver is still operational even though the transmitter 220 is powered down by the controller 250. This means that the IMD 200 is potentially capable of receiving data but not transmitting data during the power down period.

In some applications, the IMD 200 cannot in practice transmit any data to the communication unit even though its transmitter 220 is operational but the receiver 220 is powered down. This is in particular relevant when the data transmission from the IMD 200 is controlled by the communication unit. The IMD 200 and the communication unit can then both comprise a respective medical implant communication service (MICS) chip (not illustrated). In such a case, the transmitter and receiver functions of the IMD can form part of the MICS chip. Generally, the MICS chip comprises the functionalities for defining the frequency band that is used for the RF-based communication, establishing the radio link, etc. MICS chips are currently available from vendors such as Zarlink Semiconductor. The data transmission between the MICS chips could then utilize a procedure similar to Automatic Repeat Request (ARQ). This means that a data transmission made by a transmitter is acknowledged by the receiver in order to inform the transmitter that the transmitted data was correctly received. If no acknowledgement (ACK) is received or a not acknowledgement (NACK) is returned, the transmitter tries to retransmit the data.

Additionally, the MICS chip of the communication unit can be configured to grant data transmissions made by the MICS chip of the IMD 200. This means that the IMD 200 is then preferably only allowed to transmit data upon such a grant from the communication unit. The reason for such procedure is to prevent collisions that can occur when both the communication unit and the IMD 200 transmit substantially simultaneously, which will lead to high interference levels. In such an application, the IMD 200 can not receive any transmission grants from the communication unit and is therefore not informed of transmission occasion that it can utilize for data transmission until the receiver 220 once more is powered up. This means that the IMD 200 is not capable of transmitting any data packets even though its transmitter 220 is active if the receiver 220 is powered down.

A further embodiment saves even more power for the IMD 200. In this embodiment, the controller 250 triggers, based on the reception of the power down request, a power down of both the transmitter and the receiver or both the transmitting and receiving branch 220 of the transceiver. This means that the IMD 200 can neither transmit nor receive data during the power down period. Thus, the complete radio equipment of the IMD 200 could therefore be caused by the controller 250 to power down for the power down period.

The preferred embodiments of the present invention relates to an IMD 200 with a controller 250 that powers down the complete radio equipment, i.e. both the transmitter and receiver 220.

The power down of the transmitter and/or receiver 220 by the controller 250 can be effected according to different embodiments. For instance, all the equipment and functionality generally encompassed by the transmitter and/or receiver 220 can be powered down, including, among others, power amplifiers, encoders, decoders, modulators, demodulators, etc. depending on the particular implementation of the transmitter and/or receiver. Alternatively, only some of the equipment and functionality of the transmitter and/or receiver 220 are temporarily powered down by the controller 250. In such a case, the powered down equipment is preferably the ones of the transmitter and/or receiver 220 that typically consumes most power when being active and operational, such as power amplifiers. Power down as disclosed herein consequently covers both a complete shut down of at least one of the transmitter and the receiver 220 or at least a power down of one of the constituting units in the transmitter and/or receiver 220.

In a typical embodiment, the receiver 220 of the IMD 225 is connected to a receive buffer 240 arranged for at least temporarily storing data received by the receiver 220 prior forwarding up to higher levels of processing in the IMD 200. In such a case, the power down request transmitted by the communication unit and captured by the RF antenna 225 could be processed by the receiver 220, such as decoded, and could be entered in the receive buffer 240. The controller 250 can then be connected to the receive buffer 240 and implemented for parsing through the data included therein for the purpose of identifying power down requests. Alternatively, the power down requests could be communicated between the previously mentioned MICS chips preferably present in both the IMD 200 and the communication unit. The power down requests could then constitute part of the low level messaging of house keeping commands that never reaches higher levels of processing in the IMD 200. In such a case, the power down request does not need to be decoded and does not have to enter the receive buffer 240. In clear contrast, at least part of the controller functionality is implemented in the MICS chip and can directly operate on the receiver and/or transmitter 220 once the MICS chip has received the power down request without involving a general central processing unit (CPU) (not illustrated) of the IMD 200.

The controller 250 is preferably configured to not only power down the transmitter and/or receiver 220 based on received power down requests but is also responsible for power up the transmitter and/or receiver 220 again. Alternatively, the IMD 200 can comprise a dedicated power down controller and a separate power up controller, although these two preferred functionalities have been housed in the single controller 250 illustrated in the embodiment of FIG. 3. The controller 250 then preferably includes a timer or clock or such a timer or clock is accessible for the controller 250. In such a case, once the controller 250 has identified the received power down request and controlled the transmitter and/or receiver 220 to power down, it preferably starts the timer or identifies the current clock status. Once a defined period of time has lapsed, such as corresponding to the timer reaching a define end value or the clock status has reached a defined value relative the previously identified clock status, the controller 250 triggers a power up of the powered down portion of the transmitter and/or receiver 220. The power down period could be a pre-defined, default value, for instance hard coded in the IMD 250, such as using a timer counting down from a starting value to zero. Alternatively and in order to achieve an adaptation in the power down, the communication unit that compiles and transmits the power down requests to the IMD 100 can determine a length of the power down period that is suitable for the current situation. In such a case, the communication unit preferably includes a notification of the determined power down period in the power down request. The controller 250 retrieves this notification from the request in the receive buffer 240 and triggers a power up once the timer or clock has indicated that the time period defined by the notification has lapsed from the previous, last power down of the transmitter and/or receiver 220.

The IMD 200 not only includes the optional but preferred receive buffer 240 but also a transmit buffer 230 connected to the transmitter 230. The transmit buffer 220 is provided in the IMD 200 for at least temporarily storing data that is to be transmitted by the transmitter 220 using the RF antenna 225 to the communication unit. In a preferred embodiment, all data generated or collected by the IMD 200 is preferably packaged into data packets by a packet processor 290. The packaged data and/or the resulting data packets are then temporarily entered in the transmit buffer 230 before further processing and transmission by the transmitter 220.

A tag processor 260 is arranged in the IMD 200 and operates on data packets to be transmitted by the transmitter 220. The tag processor 260, in more detail, preferably parse through the transmit buffer 230 to conclude whether the IMD 200 currently has any more data that should be transmitted to the communication unit. The tag processor 260 generates a notification indicating whether the transmit buffer 230 comprises such additional data packets to be transmitted. The generated notification is tagged to at least one data packet to be wirelessly transmitted by the transmitter 220. The packet tagging of the tag processor 260 can be conducted according to various embodiments. In a typical case, the tag processor 260 sets a flag in the header of a data packet to indicate whether the transmit buffer 230 comprises additional data, such as by a flag=1_{bin} (or alternatively 0_{bin}), or whether the current data packet is the last data packet to be transmitted during the current phase of the communication session, such as by a flag=0_{bin} (or alternatively 1_{bin}). Alternatively, the tag processor 260 can enter the notification in a tail portion of the data packet. Actually, any inclusion and association of the notification to a data packet is possible and within the scope of the processing of the tag processor 260 according to the invention.

The included notification present in the data packet informs the communication unit whether more data is expected from the IMD or all requested data has now been sent to the communication unit. The notification therefore allows the communication unit to perform a selective and conditional generation of the power down request and thereby a selective power down of the transmitter and/or receiver 220 in the IMD based on whether the IMD 200 has additional data to be transmitted.

In a typical embodiment, the tag processor 260 generates and includes notifications in each data packet transmitted by the transmitter 220. The extra overhead due to the notification of the invention is next to negligible since it can be in the form of a single bit. For instance, assume that IMD 200 has collected diagnostic patient data and this raw data is too large to be contained by a single data packet. The packet processor 290 can then fragment the diagnostic data into multiple data packets, such as four data packets in an illustrative example. The first three data packets of these four data packets would then, in this embodiment, each contain a notification indicating that additional data follows. The last data packet would, though, have a different value of its included notification to indicate that the transmit buffer 230 is now empty and no more diagnostic data follows.

Instead of tagging all transmitted data packets, the tag processor 260 could include, notifications in only some of them. For instance, only the data packets carrying the last data to be transmitted to the communication unit could be tagged. This informs the communication unit that no more data follows and the power saving algorithm can be started once more to cause a power down of the transmitter and/or receiver 220 of the IMD 200. Alternatively, all data packets in a stream except the data packet carrying the last set of data could be tagged. The notification then indicates that more data follows. These two embodiments, though, have the drawback of generally requiring more than one bit for the notification as the communication unit must be able to identify the notification from the remaining bits of the data packet. If all data packets are instead tagged, the notification or flag can occupy a pre-defined bit position in, for instance, the header or tail of each data packet.

Generally, the radio communication between the IMD 200 and the data processing unit using the communication unit as communication interface towards the IMD 200 is based on a request-response procedure. Thus, the data processing unit generates a request for data from the IMD 200 that is forwarded to the communication unit and wirelessly transmitted to the IMD 200. The IMD collects the requested data and returns it to the communication unit, which forwards the data to the data processing unit. Examples of such requested data include one or more physiological parameters monitored by the IMD 200 in the animal body. The IMD 200 consequently preferably comprises a sensor or other equipment for monitoring the physiological parameter and generating data samples representative of the value of the monitored parameter.

For instance, the IMD 200 comprises an electrode I/O unit 202 comprising or being connectable to electrode terminals 204, 206. These electrode terminals 204 206 are arranged in the IMD 200 for electrical connection to respective implantable electrodes 212, 214 preferably arranged on one or more cardiac leads 210. The implantable electrodes 212, 214 are typically provided at a distal end of the cardiac lead 210 and are, in operation, introduced into or attached close to a ventricle or an atrium of the heart.

The electrode I/O unit 202 is electrically connected to the electrodes 212, 214 of the cardiac leads 210 through conductors running in the lead body from the electrodes 212, 214 at the distal end to terminals at the proximal end and through the electrode terminals 204, 206 that are electrically and mechanically attached to the terminals at the proximal end. The electrode I/O unit 202 can also be electrically connected to one or more electrodes that are not provided on the at least one cardiac lead 210. Such an electrode can actually constitute the housing or can of the IMD 200 or at least a portion thereof, which is well known in the art.

The IMD 200 comprises a data processor 280 that is connected to the electrode I/O unit 202. The data processor 280 is provided for recording sets of data samples representing the detected or sensed physiological parameter from the animal body, preferably such a physiological parameter representative of the operation of the heart of the animal body. The sample data is forwarded to the packet processor 290 that is used for organizing the input data into data packets that can be transmitted by the IMD 200.

The tagging of data packets conducted by the tag processor 260 may then be conducted on all or at least a portion of the data packets generated by the packet processor 290 and temporarily entered in the transmit buffer 230 prior transmission by the transmitter 220.

Another example of requested data includes IMD device or operation settings and other IMD device related information. As is well-known in the art, an IMD 200 generally has several programmable operation parameters or settings that can be automatically determined by the IMD 200 based on monitored physiological parameter or be determined by the physician and programmed into the IMD 200. Non-limiting examples of such parameter include AV delays, VV delays, pacing pulse magnitudes, operation modes of IMD, etc. Examples of IMD device related information includes serial number, manufacture information, current battery status level, etc. Based on the reception of a data request from the communication unit, the IMD 200 collects the relevant information of the IMD settings or status and includes this information in one or more data packets through the operation of the packet processor 290. The data packet tagging conducted by the tag processor 260 can then be conducted on these data packets.

When the communication unit forwards a reprogramming request from the data processing unit to the IMD 200, the IMD 200 can response with an acknowledgement whether the programming of the relevant IMD parameter or operation setting was correctly conducted or whether reprogramming could not be effected. Also data packets comprising such acknowledgement responses can be tagged by the tag processor 260 of the invention.

As was mentioned in the background section, a particular embodiment of a power save algorithm can be based on the periodicity of the EGM stream from the IMD 200. In that embodiment, the data requests generated by the data processing unit and forwarded to the IMD 200 through the communication unit preferably relates to other data besides EGM data. The response data collected by the IMD 200 and preferably entered in the receive buffer 240 is other diagnostic data than EGM samples and/or device data. Thus, the tag processor 260 preferably investigates whether the IMD 200 and more preferably the transmit buffer 230 comprises any such non-EGM data when determining the value of the tagged notification.

In some applications the communication unit regularly conducts a keep-alive investigation during the ongoing communication session. Such a keep-alive investigation is basically used for verifying the current communication link status and detect if the communication link has been lost. Such a keep-alive investigation can be conducted by regularly, such as every 200 ms, transmitting dedicated keep-alive requests from the communication unit to the IMD 200. The communication unit then expects the IMD 200 to return keep-alive responses within a specified time frame.

The data packet tagging of the tag processor 260 can also be used in connection with such keep-alive responses. In such a case, the receiver 220 receives a keep-alive request from the communication unit. An optional response processor 270 of the IMD 200 processes the request and generates a keep-alive response based on reception of the request. The tag processor 260 investigates whether the transmit buffer 230 comprises any data or data packets that need to be transmitted to the communication unit. The data or data packets generally has no connection with the keep-alive procedure but could instead include physiological data collected by the IMD 200 or data indicative of the current IMD operation status. Irrespective of the particular data type that might be present in the transmit buffer 230, the tag processor 260 generates the notification and adds it to the keep-alive response from the response processor 270 before it is transmitted to the communication unit.

If the IMD 200 participates in a keep-alive investigation as disclosed above, the tag processor 260 could be configured to only tag keep-alive responses. This means that data packets carrying other kind of response data will not be tagged with a notification. In clear contrast, the keep-alive responses are used as the sole notifying data packets or messages regarding information needed to enable the selective generation of power down requests according to the invention.

In an alternative embodiment, the tag processor 260 tags both keep-alive response and other data packets and messages transmitted by the IMD 200. In such a case, all data packets leaving the transmitter 220 can include a field containing the notification generated by the tag processor 260 and indicative of the current transmit buffer status 230 of the IMD 200.

FIG. 3 merely illustrates the units of an IMD 200 that are directly involved in embodiments as disclosed herein. It is therefore anticipated that the IMD 200 comprises additional units that are not illustrated in the figure and that are not directly involved in the operation of the disclosed embodiments.

The units 202, 220 to 290 of the IMD 200 may be provided as hardware or a combination of hardware and software. Alternatively, these units of the IMD 200 are implemented in software. In such a case, a computer program product implementing the IMD 200 or a part thereof comprises software or a computer program run on a general purpose or specially adapted computer, processor or microprocessor of the IMD 200. The software includes computer program code elements or software code portions illustrated in FIG. 3. The program may be stored in whole or part, on or in one or more suitable computer readable media or data storage means such as hard discs, magneto-optical memory, in RAM or volatile memory, in ROM or flash memory.

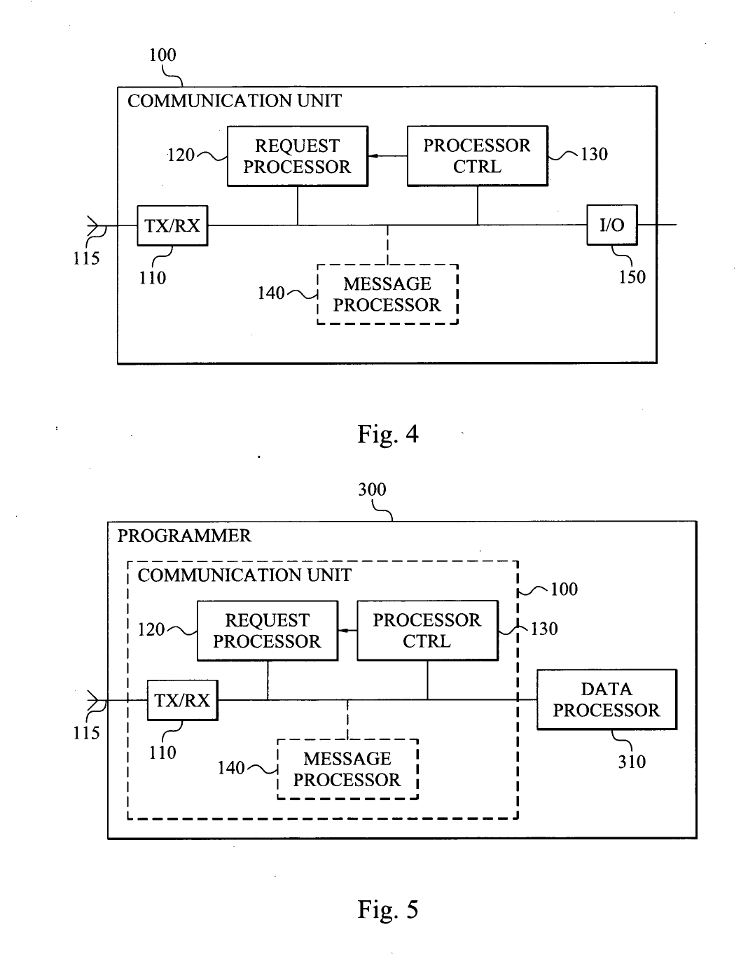

FIG. 4 is a schematic block diagram of an embodiment of the communication unit 100 capable of conducting wireless RF-based communication with an IMD. The communication unit 100 in particular comprises a receiver 110 connected to a RF antenna 115 and arranged for receiving data packets transmitted by the IMD. The receiver 110 can be a dedicated RF receiver or represent the receiving branch of a combined RF transmitting and receiving unit or transceiver. In the former case, the communication unit 100 also comprises a RF transmitter 110 connected to the same RF antenna 115 or a dedicated RF transmitter antenna.

The communication unit 100 also comprises a request processor 120 connected to the transmitter 110. The request processor 120 is responsible for generating the power down requests that are communicated to the IMD and cause the controller implemented therein to power down at least one of the transmitter and the receiver of the IMD. According to the invention this generation and transmission of power down requests is made conditional on the notifications tagged on data packets received by the receiver 110 and therefore made conditional on whether the IMD has additional data to be transmitted to the communication unit 100.

A processor controller 130 of the communication unit 100 controls the operation of the request processor 120 and the generation of the power down requests based at least partly on the received notification tags. Thus, the processor controller 130 retrieves notifications from data packets received by the receiver 110 and originating from the IMD. The processor controller 130 additionally generates activation or deactivation control commands based on the particular values of the retrieved notifications.

In more detail, in a preferred embodiment, the processor controller 130 generates a deactivation control command if the latest received notification in a data packet indicates that the IMD comprises additional data to be sent to the communication unit 100. The deactivation control command deactivates and prevents the request processor 120 from generating a power down request even if the communication unit 100 and the IMD are currently operating according to a power saving algorithm. Correspondingly, if the processor controller 130 confirms that the IMD does not have any more pending data packets to transmit based on the notification present in the latest received and tagged data packet, the processor controller 130 generates an activation control command. This activation control command triggers the request processor 120 to anew start the generation of power down requests that are transmitted to the IMD.

Consequently, if the IMD comprises data to be communicated to the communication unit 100, the transmitter/receiver power down is at least temporarily postponed through the notification-based deactivation control command from the processor controller 130 and applied to the request processor 120. If however the IMD currently has no more data that needs to be transmitted to the communication unit 100 based on a previously communicated data request, the request processor 120 advantageously generates a power down request based on the activation control command generated by the processor controller 130 in response to a received notification.

In addition to performing the generation and transmission of power down requests conditional on the received notification tags, the processor controller 130 preferably also generates a deactivation command signal once the communication unit 100 receives a data request from a connected data processing unit. The communication unit 100 therefore comprises a general input and output (I/O) unit 150 operating as the interface between the communication unit 100 and the connected data processing unit. The I/O unit 150 can, in particular in the case of a wired connection, represent the equipment of the communication unit 100 allowing forwarding of data from the communication unit 100 to the data processing unit and vice versa over the wired connection. In the case of a wireless communication, the I/O unit 150 represents the equipment, such as transmitter/receiver and antenna, required in order to effectuate such a wireless data transfer.

The I/O unit 150 consequently receives data requests from the data processing unit and forwards these requests to the transmitter 110 that processes them to generate a data request packet or packets that can be wirelessly transmitted using the connected antenna 115 to the IMD.

The processor controller 130 is preferably also activated based on the reception of such a data request by the I/O unit 150. This means that the processor controller 130 preferably generates a deactivation control command and forwards it to the request processor 120 to temporarily prevent the processor 120 from generating any power down request destined to the IMD. The reason for this temporary stop in generating and transmitting power down requests is that the data request that has newly or will soon be transmitted to the IMD causes the IMD to respond by replying with the requested data. It is therefore inefficient if the communication unit 100 would request a transmitter/receiver power down immediately following the transmission of the data request.

In some cases it could be possible that the communication unit 100 almost simultaneously receives a data packet from the IMD tagged with a notification that the IMD does not contain additional data that needs to be transmitted and a data request from the data processing unit via the I/O unit 150. According to the tag, the processor controller 130 can generate an activation control command whereas the data request preferably prevents the generation and transmission of power down request and therefore no such activation control command should be generated. This conflict is preferably solved by giving higher priority to the messages originating from the data processing unit. Therefore, the processor controller 130 preferably generates, in such a conflict situation, a deactivation control command to prevent the request processor 120 from generating any power down request. Instead the data request is transmitted to the IMD and response data therefrom is expected.

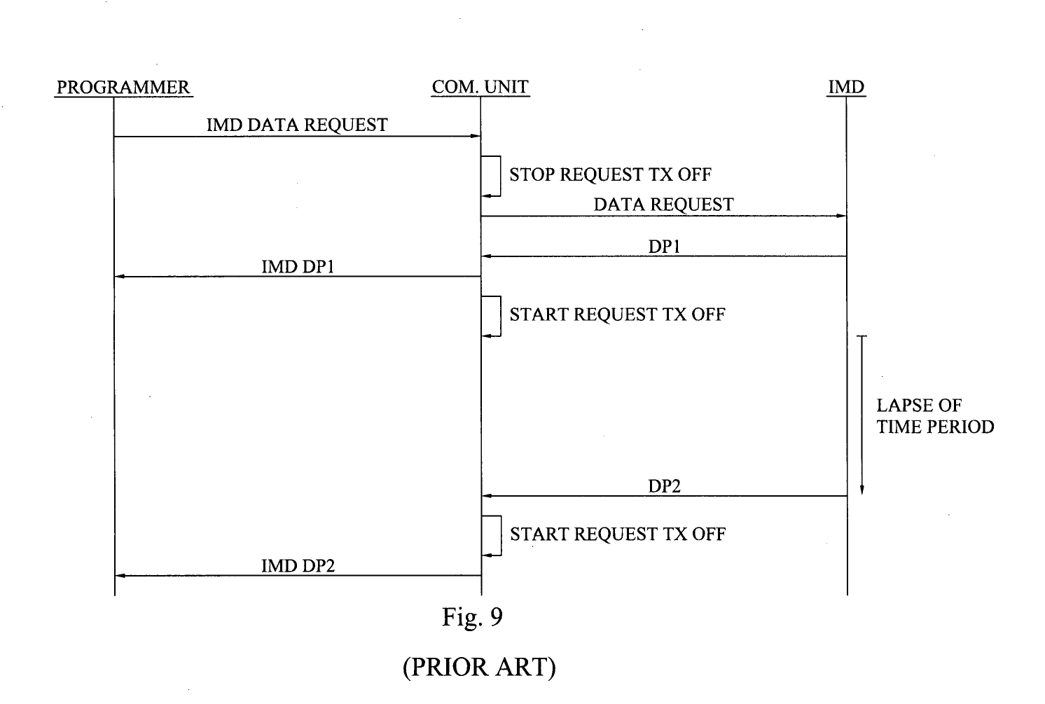

The present invention temporarily prevents or postpones power down requests from the request processor 120 until the IMD has transmitted all the requested data. This is a clear distinction to the prior art solutions. In those solutions the request processor 120 could have generated a power down request that is sent to the IMD even though the IMD has not yet transmitted all the requested data. This may happen since the request processor 120 according to the prior art is activated regardless of whether all requested data has been communicated from the IMD. Therefore a prior art session could be conducted as illustrated in the signal diagram of FIG. 9.

The programmer (data processing unit) generates and transmits a data request destined to the IMD. The data request reaches the communication unit, where the processor controller temporarily deactivates the request processor and thereby temporarily stops the power down request generation and transmission. The received data request is wirelessly transmitted to the IMD, which in response thereto provides the requested data. In this illustrative example, the amount of response data is too large to fit in a single data packet and instead requires two data packets. The IMD therefore compiles and transmits the first data packet (DP1) to the communication unit. The relevant payload data included therein is retrieved and forwarded using the I/O unit to the programmer. In the meantime the request processor generates and transmits a new transmitter/receiver power down request to the IMD. The IMD must therefore power down its radio equipment in response to the power down request and can therefore not transmit the remaining response data to the communication unit until the power down time period, such as 20-30 ms and depending on the particular implementation design, has lapsed. After expiry of this time period the IMD radio equipment is once more powered up and the IMD can transmit the last data packet (DP2) with the remaining response data to the communication unit, which forwards the payload data therein to the programmer. The communication unit further anew requests power down of the IMD radio equipment unless the communication session should be ended. The result of the prior art technique is a prolonging of the communication session, which will result in the previously described problems for the IMD and the longevity of its operation.

The communication unit 100 as illustrated in FIG. 4 may optionally utilize the previously described keep-alive request/response procedure in order to verify the current communication link status. In such a case, the communication unit 100 preferably comprises a message processor 140 adapted to generate a keep-alive request, which is transmitted by the transmitter 110 to the IMD. If the communication link is correct, the IMD will reply with a keep-alive response that is captured by the receiver 110. The notification regarding data packet pending status of the IMD can then be tagged to such keep-alive responses. The processor controller 130 therefore preferably investigates received keep-alive responses in order to retrieve such notification therefrom and control the operation of the request processor 120 based on the values of the retrieved notifications.

FIG. 4 is a schematic illustration of the main functionalities in a communication unit 100 as used in the data communication system illustrated in FIG. 1. In FIG. 5, which corresponds to the data communication system of FIG. 2, the communication unit 100 and the data processor 310 are implemented in the same device, such as a programmer 300. Generally, no dedicated I/O unit is therefore needed but can of course be used between the communication unit 100 and the data processor 310.

The units 110-150 of the communication unit 100 may be provided as hardware or a combination of hardware and software. Alternatively, these units of the communication unit 100 are implemented in software. In such a case, a computer program product implementing the communication unit 100 or a part thereof comprises software or a computer program run on a general purpose or specially adapted computer, processor or microprocessor. The software includes computer program code elements or software code portions illustrated in FIG. 4 or 5. The program may be stored in whole or part, on or in one or more suitable computer readable media or data storage means such as magnetic disks, CD-ROMs, DVD disks, USB memories, hard discs, magneto-optical memory, in RAM or volatile memory, in ROM or flash memory, as firmware, or on a data server.

FIGS. 4 and 5 only illustrate the units of the communication unit and programmer directly involved in the operation of the embodiments. Additionally units known in the art can also be included therein.

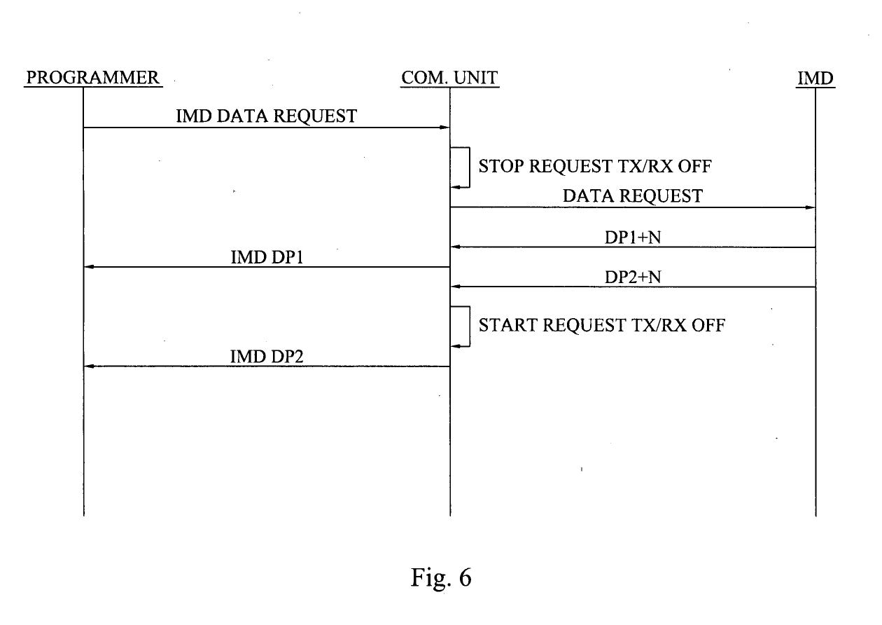

FIG. 6 is a signal diagram illustrating an example of the communication conducted between a programmer, a communication unit and an IMD. The signaling as illustrated in this example is generally the same as in the prior art example of FIG. 9 up the forwarding of the data request to the IMD by the communication unit. This means that the programmer has generated and transmitted the data request to the communication unit, where the data request triggers a temporary deactivation of the generation and transmission of power down requests.

Also in this example it is assumed that the response data collected by the IMD based on the received data request needs two data packets. The IMD consequently compiles and transmits a first data packet (DP1) comprising a portion of the response data. In clear contrast to the prior art scheme of FIG. 9, this data packet is tagged with a notification (N) indicating that the IMD has additional response data that is to be transmitted to the communication unit in response to the data request.

The communication unit retrieves the payload data from the received data packet and forwards it to the programmer for further processing, such as display on a display screen. The notification included in the data packet indicates that additional data is present in the transmit buffer of the IMD and consequently causes the processor controller of the communication unit to generate the deactivation control command to temporarily prevent the request processor to generate any new power down request. As a consequence, the radio equipment of the IMD is not powered down but the IMD can instead compile and transmit a second data packet (DP2) with the remaining response data. This data packet additionally comprises a notification indicating that the IMD does not have any more pending data to transmit to the communication unit.

The communication unit retrieves and forwards the payload data of the second data packet in similarity to the first data packet. The attached notification informs the processor controller that it now can active the request processor to thereby generate and transmit a power down request to the IMD since no more data is expected from the IMD.

Comparing the signaling conducted according to an embodiment of the invention as illustrated in FIG. 6 with the signaling according to the prior art in FIG. 9, it is evident that the total time for this request-response part of the communication session is much shorter for the invention. The reduction in communication session time achieved by the invention enables the previously discussed advantages in terms of increased IMD longevity, decreased power consumption and faster interrogation.

In other applications, the data processing unit can generate multiple different data request that are sent stacked after each other to the IMD through the communication unit. The IMD then has to compile response data to all of the data requests. The benefits of the invention can be even more pronounced in such an application as all the response data could be transmitted to the communication unit before the power down of the IMD radio equipment. In the prior art, multiple power down periods would typically have been requested by the communication unit before all response data had been transmitted by the IMD.

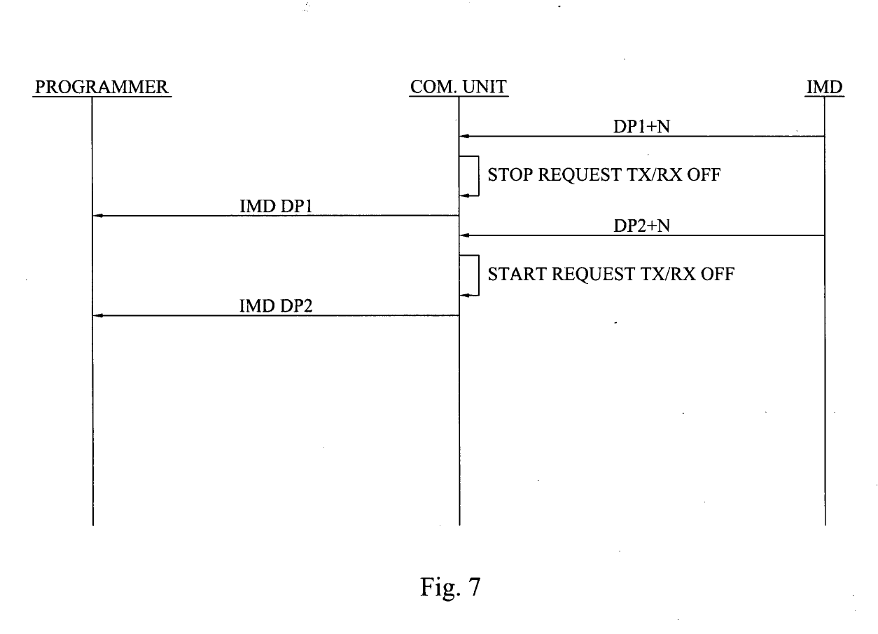

FIG. 7 is a signal diagram illustrating another embodiment, in which notifications of the invention can be used. In FIG. 6, the signaling is based on a so-called request-response procedure, in which the IMD only compiles and transmits data to the communication unit based on a data request originating from programmer. FIG. 7 illustrates that the IMD generates and transmits data to the communication unit during an ongoing communication session but without the need for any data requests.

In similarity to FIG. 7, the data packets transmitted by the IMD are tagged with notifications indicating whether the IMD comprises any additional data (packet) to be transmitted to the communication unit. In the particular example illustrated in FIG. 7, the IMD will transmit two data packets to the communication unit. The first data packet (DP1) is consequently tagged with a notification that there are additional data (packets) pending in the IMD transmit buffer. The notification causes the communication unit to temporarily stop the generation and transmission of power down requests. The second data packet (DP2) is tagged with a notification that no further data that should be communicated is present in the IMD. The communication unit consequently activates the generation and transmission of power down requests to thereby cause a power down of, preferably, the complete radio equipment of the IMD. In similarity to FIG. 6, the payload data from the received data packets is preferably forwarded from the communication unit to the programmer.

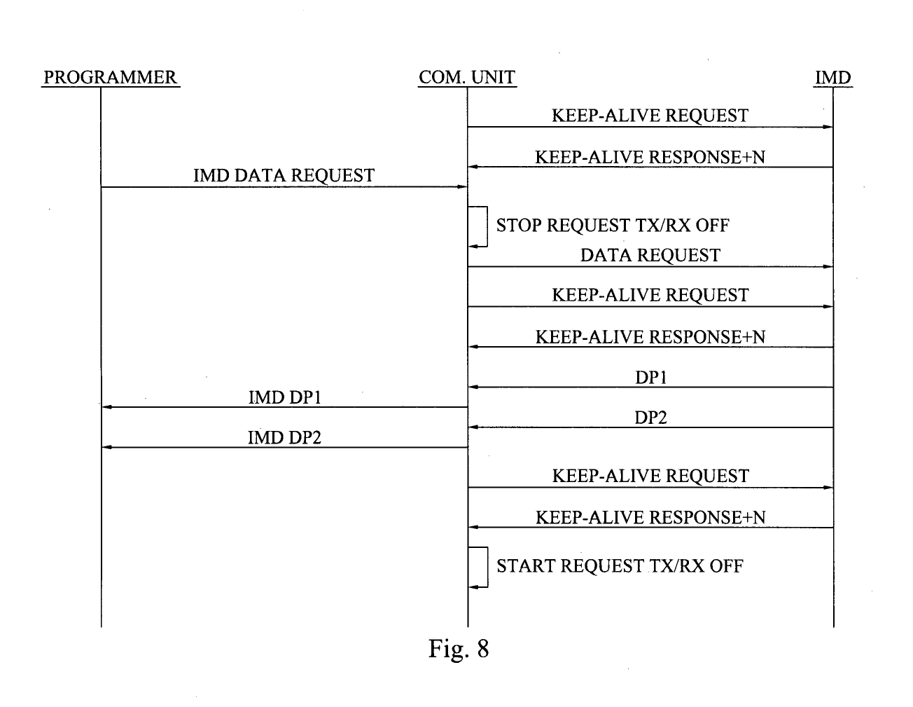

FIG. 8 is a signal diagram illustrating usage of the keep-alive request/response procedure. In the illustrated part of the communication session, the communication unit compiles and transmits a keep-alive request to the IMD in order to verify the current communication link status. The IMD replies with a keep-alive response that is tagged according to the invention with a notification indicating that there is no pending data to be transmitted to the communication unit. The power saving procedure can therefore be continued in the form of requiring power down of radio equipment in the IMD.

However, in this case the programmer would like to retrieve data from the IMD and consequently generates a data request that is forwarded to the communication unit.

The communication unit temporarily stops the generation and transmission of power down requests based on the data request and additionally transmits the data request to the IMD.

In the meantime the preferably fixed time period between transmitting keep-alive requests has now expired in this example and the communication unit consequently transmits a new keep-alive request to the IMD. The IMD replies with a keep-alive response tagged with a notification. In contrast to the previous keep-alive response, the notification now indicates that additional data is pending for transmission in the IMD. The notification causes the communication unit to temporarily stop the generation and transmission of power down requests or keep such generation deactivated if already stopped.

The IMD transmits the request data, in this case in the form of two data packets. The communication unit retrieves the payload data therefrom and forwards it to the communication unit.

Once more the fixed time period between transmitting keep-alive requests has expired and the communication unit transmits a new such keep-alive request. The IMD has now communicated all response data and therefore the notification tagged to the keep-alive response indicates that a power down request can be issued since no more data need to be transmitted by the IMD. The communication unit consequently anew starts requesting power down of the IMD radio equipment.

In the signal diagram of FIG. 8, only the keep-alive responses are tagged with notifications by the IMD. In an alternative embodiment, also the data packets comprising the response data could be tagged. In such a case, the power down request from the communication unit could have been transmitted directly after reception of the second data packet (DP2) instead of awaiting the following keep-alive response. The communication unit would then not have sent any keep-alive request until the defined power down time period has lapsed as the IMD preferably cannot receive or transmit any data until the lapse of the power down time period.

In the signal diagrams of FIGS. 6 and 8, the programmer and communication unit have been illustrated as separate devices with a communication interface therebetween. The two devices may though be housed within the same physical device and then the signaling of FIGS. 6 to 8 represents the communication of data between different functionalities in the physical device.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1-20. (canceled)

21. An implantable medical device comprising:
a receiver coupled to a radio frequency antenna;
a transmitter coupled to a radio frequency antenna and adapted to wirelessly transmit data packets;
a controller coupled to at least one of the transmitter and the receiver and adapted to power down the at least one of the transmitter and the receiver based on a power down request received by the receiver;
a transmit buffer connected to the transmitter and adapted to at least temporarily store data packets to be transmitted by the transmitter; and
a tag processor connected to the transmit buffer and adapted to tag a data packet to be wirelessly transmitted by the transmitter with a notification indicating whether the transmit buffer comprises additional data to be wirelessly transmitted by the transmitter, the notification allowing a selective generation of the power down request by a non-implanted communication unit and a selective power down of the at least one of the transmitter and the receiver.

22. The implantable medical device according to claim 21, wherein the controller is adapted to power up the at least one of the transmitter and the receiver after lapse of a defined time period following a power down of the at least one of the transmitter and the receiver by the controller, wherein the power down request optionally comprises a notification of the defined time period.

23. The implantable medical device according to claim 21, wherein the receiver is adapted to receive a data request, the implantable medical device further comprising:
a data processor adapted to generate, based on the data request received by the receiver, response data; and
a packet processor connected to the data processor and adapted to generate data packets based on the response data generated by the data processor, wherein the tag processor is adapted to tag at least a portion of the data packets generated by the packet processor.

24. The implantable medical device according to claim 21, wherein the receiver is adapted to receive a keep-alive request, the implantable medical device further comprising a response processor adapted to generate a keep-alive response based on reception of the keep-alive request by the receiver, the tag processor is adapted to tag the keep-alive response with the notification.

25. A communication unit for conducting wireless communication with an implantable medical device, the communication unit comprises:
a receiver connected to a radio frequency antenna and adapted to receive data packets transmitted by the implantable medical device;
a request processor adapted to generate a power down request defining a power down of at least one of a transmitter and a receiver of the implantable medical device;
a transmitter connected to a radio frequency antenna and adapted to wirelessly transmit the power down request to the implantable medical device; and
a processor controller connected to the request processor and adapted to selectively control the request processor to generate or stop generating the power down request based on a notification indicating whether a transmit buffer of the implantable medical device comprises additional data packets to be wirelessly transmitted to the communication unit, the notification being present in a data packet received by the receiver from the implantable medical device.

26. The communication unit according to claim 25, wherein the transmitter is adapted to transmit a data request to the implantable medical device, the data request urging the implantable medical device to generate response data, and the processor controller is adapted to deactivate and prevent the request processor from generating the power down request if the communication unit receives the data request from a connected data processing unit.

27. The communication unit according to claim 25, wherein the processor controller is adapted to deactivate and prevent the request processor from generating the power down request if the receiver receives a data packet from the implantable medical device comprising a notification indicating that the transmit buffer of the implantable medical device comprises additional data to be wirelessly transmitted to the communication unit.

28. The communication unit according to claim 25, wherein the processor controller is adapted to activate the request processor to generate the power down request if the receiver receives a data packet from the implantable medical device comprising a notification indicating that the transmit buffer of the implantable medical device does not comprise additional data to be wirelessly transmitted to the communication unit.

29. The communication unit according to claim 25 further comprising a message processor adapted to generate a keep-alive request, wherein the transmitter is adapted to periodically transmit the keep-alive request to the implantable medical device during an ongoing communication session, the keep-alive request urging the implantable medical device to respond with a keep-alive response comprising the notification.

30. A data communication method comprising:
tagging a data packet to be wirelessly transmitted by a transmitter connected to a radio frequency antenna of an implantable medical device with a notification indicating whether a transmit buffer of the implantable medical device comprises additional data to be wirelessly transmitted by the transmitter; and
wirelessly transmitting the data packet to a non-implanted communication unit, wherein the notification allowing a selective generation by the non-implanted communication unit of a power down request triggering a power down of at least one of the transmitter and a receiver of the implantable medical device.

31. The data communication method according to claim 30, further comprising:
receiving the power down request from the non-implantable communication unit; and
temporarily deactivating the at least one of the transmitter and the receiver based on the request message for a time period optionally notified in the power down request.

32. The data communication method according to claim 30, further comprising:
receiving a data request from the non-implantable communication unit;
collecting, based on the data request, response data;
generating data packets based on the response data; and
temporarily storing the data packets in the transmit buffer, wherein the tagging step comprises tagging at least a portion of the data packets with the notification.

33. The data communication method according to any of the claims 30, further comprising:
periodically receiving a keep-alive request; and
generating a keep-alive response based on reception of the keep-alive request message, wherein the tagging step comprises tagging the keep-alive response with the notification.

34. A communication control method comprising:
generating power down requests defining a power down of at least one of a transmitter and a receiver of an implantable medical device;
receiving, from the implantable medical device, a data packet tagged with a notification indicating whether the implantable medical device comprises additional data to be wirelessly transmitted by the transmitter; and
stopping the generation of the power down request if the notification indicates that the implantable medical device comprises additional data to be wirelessly transmitted by the transmitter.

35. The method according to claim 34, further comprising starting the generation of the power down requests if the notification indicates that the implantable medical device does not comprise additional data to be wirelessly transmitted by the transmitter.

38. The method according to claim 34, further comprising transmitting the power down requests to the implantable medical device.

37. The method according to any of the claim 34, further comprising stopping the generation of the power down requests based on reception of a data request to be transmitted to the implantable medical device, the data request urging the implantable medical device to generate response data.

38. The method according to any of the claim 34, further comprising:
generating a keep-alive request; and
periodically transmit the keep-alive request to the implantable medical device during an ongoing communication session, the keep-alive request urging the implantable medical device to respond with a keep-alive response comprising the notification.
